(19) United States
(12) Patent Application Publication
(10) Pub. No.: US 2007/0036445 A1
(43) Pub. Date: Feb. 15, 2007

(54) Method and apparatus of efficient lossless data stream coding

(76) Inventors: Shih-Chuan Lu, Kaohsiung (TW); Wei-Ting Jwo, Taichung (TW)

Correspondence Address: Chih-Ta Star SUNG;RM. 308, BLD. 52, NO. 195, CHUNG HSING RD., SEC. 4, CHU TUNG TOWNSHIP, 310, TW

(21) Appl. No.: 11/205,301

(22) Filed: Aug. 15, 2005

(51) Int. Cl. G06K 9/36

(52) U.S. Cl. 382/238; 382/244

(57) ABSTRACT

The present invention provides method of lossless data stream coding with high coding efficiency. The differential value of adjacent samples are calculated firstly and is coded by a VLC coding, the variable length coding. The VLC coding includes codes representing the quotient and remainder with a marker bit inserted in between. The divider is implicitly encoded and decoded with no code in the coded data stream. For pursuing high performance, at least two VLC encoder and VLD decoder are adopted to encode and decode the samples with one input from one location of the data stream and another input from another location of the data stream and the results saving from one location of the storage device and another result of data stream saving from another location of the storage device.

### BACKGROUND OF THE INVENTION

1. Field of Invention

The present invention relates to data compression and, more specifically to a method and apparatus of efficiently and quickly lossless coding the data.

2. Description of Related Art

Efficient data coding plays important role in lower cost in storage and higher speed in data transmission either in wired or wireless data transmission. Another advantage of an efficient data coding is the lower power consumption in storage and data transmission due to the less data rate after efficient data coding.

Prior art data coding, or so called “data compression” coding uses mostly either inefficient DPCM, the differential pulse coded modulation enhanced by one kind of entropy coding or by a complex data transform enhanced by quantization/filtering and a kind of entropy coding. The former has disadvantage of lower compression rate, inefficient in reducing data rate. The later has relatively higher complexity in implementation and quite significant loss of data resulting in quality degradation.

This invention is to overcome the issues of high computing power and hence reduces the cost of implementation as well as maintaining top quality compare to the original data.

### SUMMARY OF THE INVENTION

The present invention of efficient lossless data steam coding reduces data rate without causing much difference from original data which maintains top quality compared to other counterparts data coding algorithms.
The present invention of efficient lossless data steam coding calculates the difference between adjacent samples and codes the differential values by applying one kind of variable length coding skill.
According to an embodiment of this invention of efficient lossless data stream coding, the differential value is divided by a predicted divider, the value of Quotient and Remainder are coded by assigning number of “0s” to represent the values of the Quotient as well as the Remainder.
According to an embodiment of this invention of efficient lossless data steam coding, the predicted divider is represented by a natural number of the power of 2.
According to an embodiment of this invention of efficient lossless data stream coding, the codes of Quotient and Remainder are separated by assigned number of “1”.
According to an embodiment of this invention of efficient lossless data stream coding, the differential values of a group of pixels are separately encoded by VLC coding in parallel.
According to an embodiment of this invention of efficient lossless data stream coding, the value of the divider is calculated by weighted factor of latest divider and previously calculated divider.
According to an embodiment of this invention of efficient lossless data stream coding, the initial divider number is calculated by a statistical number of previous samples.
According to an embodiment of this invention of efficient lossless data stream coding, the initial value of the divider of a group of samples is predicted with complex patterns using larger divider and less complex patterns smaller divider.
According to an embodiment of this invention of efficient lossless data stream coding, the value of the divider is calculated by weighted factor of latest divider and previously calculated divider with the latest divide having 50% of the weight and the previous divider having the rest of 50% of weight.

It is to be understood that both the foregoing general description and the following detailed description are by examples, and are intended to provide further explanation of the invention as claimed.

### BRIEF DESCRIPTION OF THE DRAWINGS

FIG. 1A shows a figure of the time modulated samples of signals.

FIG. 1B depicts a prior art of DPCM+an entropy coding.

FIG. 1C illustrates a prior art of the JPEG, the still image data compression coding algorithm.

FIG. 2 depicts the flowchart of this invention of efficient lossless data encoding.

FIG. 3 depicts the flowchart of this invention of efficient lossless data decoding.

FIG. 4 depicts the flowchart of the threshold setting of coding the “Quotient”.

FIG. 5 illustrates the flowchart of this invention of efficient lossless data encoding by a pipelining architecture by 4 clock cycles.

FIG. 6 illustrates the flowchart of this invention of efficient lossless data encoding by a pipelining architecture by 5 clock cycles.

FIG. 7 illustrates the flowchart of this invention of efficient lossless data decoding by a pipelining architecture.

FIG. 8 depicts the block diagram of this invention of an apparatus of efficient lossless data encoding of Quotient and Remainder.

FIG. 9 depicts the block diagram of the apparatus of decoding the data of this invention.

FIG. 10 illustrates the procedure of high performance of encoding and decoding the image.

### DESCRIPTION OF THE PREFERRED EMBODIMENTS

The present invention relates specifically to the data stream coding for data reduction while still maintaining good quality. The present invention significantly reduces the amount of data of image and audio data and stored in a storage device, and correspondingly reduces the density, bandwidth requirement and cost of storage devices for storing streaming data.

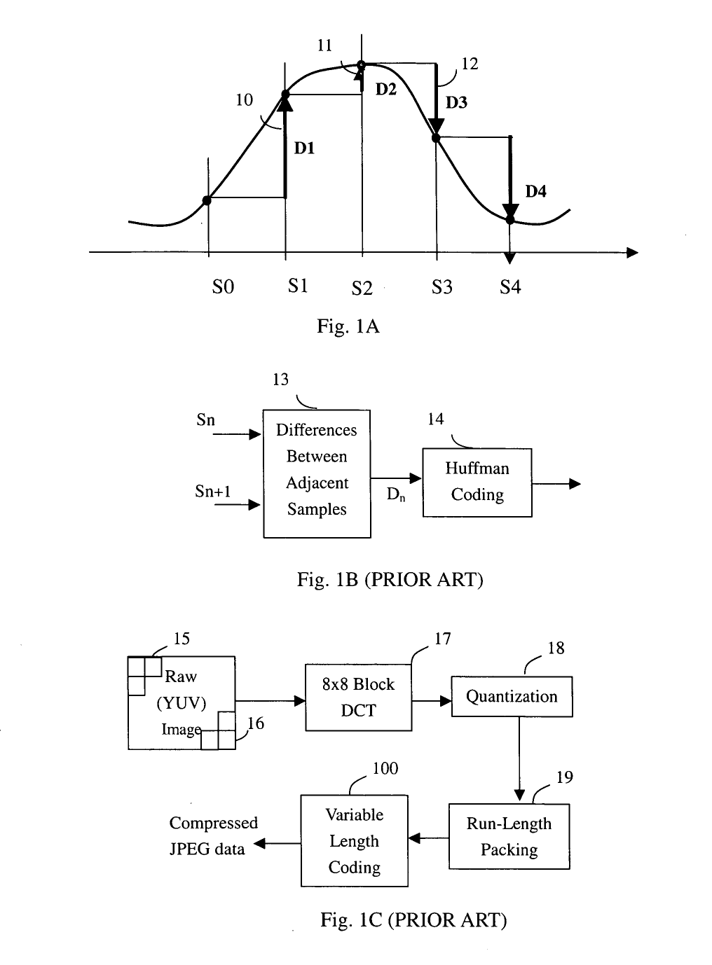

FIG. 1A illustrates examples of the time modulated coded sampled data S0, S1, S2, S3, S4 . . . or so called Pulse Coded Modulation (PCM) data. Assigning a certain fixed length of bits to represent each sample, this kind of data coding requires higher data rate. In the past decades, many data coding algorithms have been developed to reduce the data rate or said to compress the data. One of the popular prior art of data stream coding is the DPCM, the Differential Pulse Coded Modulation backing up by the entropy coding. Which means that the differential values D1, D2, D3, 10, 11, 12, . . . between adjacent samples are calculated and coded by an entropy coding. The entropy coding uses the shortest code to represent the most frequent show up pattern, and longest code to represent the least frequent show up patter. FIG. 1B depicts the commonly used algorithm of data reduction. The difference 13 between sampled data is calculated and sent to the Huffman coding unit 14 for the entropy coding to further reduce the data rate. The Huffman coding is one of the most popular entropy coding. Both the DPCM and VLC are lossless compression and together can also result in lossless compression. In image and audio applications, this kind of DPCM plus VLC coding can achieves the data reduction rate by a factor of 1.3X to 1.7X. which for many applications is not attractive.

Another popular data compression coding algorithm is the still image compression standard named JPEG as shown in FIG. 1C. JPEG compression includes some procedures in coding data stream. The color space conversion is to separate the luminance (brightness) from chrominance (color) and to take advantage of human being's vision less sensitive to chrominance than to luminance and the can reduce more chrominance element without being noticed. An image is partitioned into many units of so named “Block” 15, 16 of 8×8 pixels to run the JPEG compression. A color space conversion mechanism transfers each 8×8 block pixels of the R(Red), G(Green), B(Blue) components into Y(Luminance), U(Chrominance), V(Chrominance) and further shifts them to Y, Cb and Cr. JPEG compresses 8×8 block of Y, Cb, Cr by the following procedures:
Step 1: Discrete Cosine Transform (DCT)
Step 2: Quantization
Step 3: Zig-Zag scanning
Step 4: Run-Length pair packing and
Step 5: Variable length coding (VLC).

DCT 17 converts the time domain pixel values into frequency domain. After transform, the DCT “Coefficients” with a total of 64 subband of frequency represent the block image data, no long represent single pixel. The 8×8 DCT coefficients form the 2-dimention array with lower frequency accumulated in the left top corner, the farer away from the left top, the higher frequency will be. Further on, the closer to the left top, the more DC frequency which dominates the more information. The more right bottom coefficient represents the higher frequency which less important in dominance of the information. Like filtering, quantization 18 of the DCT coefficient is to divide the 8×8 DCT coefficients and to round to predetermined values. Most commonly used quantization table will have larger steps for right bottom DCT coefficients and smaller steps for coefficients in more left top corner. Quantization is the only step in JPEG compression causing data loss. The larger the quantizationj step, the higher the compression and the more distortion the image will be.

After quantization, most DCT coefficient in the right bottom direction will be rounded to “0s” and only a few in the left top corner are still left non-zero which allows another step of said “Zig-Zag” scanning and Run-Length packing 19 which starts left top DC coefficient and following the zig-zag direction of scanning higher frequency coefficients. The Run-Length pair means the number of “Runs of continuous 0s”, and value of the following non-zero coefficient. The Run-Length pair is sent to the so called “Variable Length Coding” (VLC) 100 which is an entropy coding method. The entropy coding is a statistical coding which uses shorter bits to represent more frequent happen patter and longer code to represent the less frequent happened pattern. The JPEG standard accepts “Huffman” coding algorithm as the entropy coding. VLC is a step of lossless compression. JPEG is a lossy compression algorithm.

The JPEG picture with less than 10X compression rate has acceptable good image quality, 20X compression will have more or less noticeable quality degradation. The JPEG image data stream coding costs relatively high computing power. For example, in software solution with a single CPU of 16 its data, it requires about 40 MIPS to encode a picture of 1M pixels of data within 1 second. The time distribution for encoding an JPEG image with 1M pixels is as the following: The total block number: 23,400, 1024 Macs of each block, So, DCT requires a total of 24M Macs (or 24 MIPS), quantization requires about ⅕of that of DCT (or 5 MIPS), others dominates about another ⅕of DCT computing time (or 5 MIPS). That comes out of ˜40 MIPS.

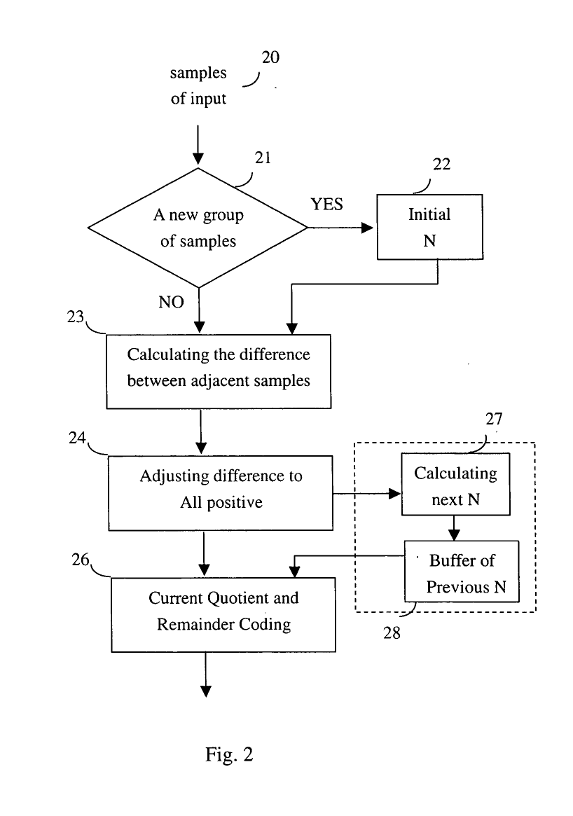

This invention of efficient lossless data stream coding applies a new method and apparatus of the VLC coding to achieve higher coding efficiency. FIG. 2 illustrates the flowchart of this invention of the efficient data stream coding. An encoder firstly calculates the differential value 23 between adjacent samples. And then adjusts the differential value to positive 24 if it is negative value according to the value of the next sample. The adjusted difference is then sent to a VLC encoder to further reducing the data rate according to the equation:
Diff.=Q×M+R (Q: Quotient, M: divider and R: Remainder) (Eq. 1)

This method of efficiently coding is to code the “Q, quotient”, a “N” of a 2^{N} representing “M, divider” and “R, remainder”. The VLC coding in this invention of efficient lossless data stream coding includes the following procedures:
Calculating the quotient. 26
Calculating the remainder. 26
Implicitly calculating the N 27, the value of 2^{N} of the divider, M without assigning a code to represent it.
   For saving code, the N is predicted by examining the previous N and latest Diff. value to be coded. Based on the principle of high continuity of either adjacent image or audio sample, the divider, M of current sample can be predicted and needs no individual code to represent it. 1^{st} step of the VLC coding is to predict the value of M as illustrated by the means of predicting the value of M.
   Mₙ=(Mₙ₋₁+Dₙ)/2 (Eq. 2)
   For example: Diff.=3=1×2+1, in the VLC coding of this invention, the quotient, Q=1 and Remainder, R=1 are the only two parameters needed to be coded with the M=2 (N=1) implicitly predicted by an average of weighted factors times Ms of previous pixels.

As one can see that from Eq. 2, the Dₙ of the closest previous sample has highest weight of ½, the next sample will have a factor of ¼, . . . etc. the farer the samples, the lower value the weighted factors and less influence to the present sample in predicting the divider, M. The coding of R is based on binary coding. Taking the last example, the R=1 will be coded by two bits of “0”. The Q will be coded by continuous “0” and stopped by adding “1”. For instance, if Q=3 will be coded by 0001 and followed by R which is also represented by “0”. So, for a number of a predicted divider M=2, Q=1 and R=1, the final code will be “010” for the the 1^{st} “0” represent Q=1, the last “0” represent R=1. The previously predicted N, 28, is applied to encode the present Q and present R.

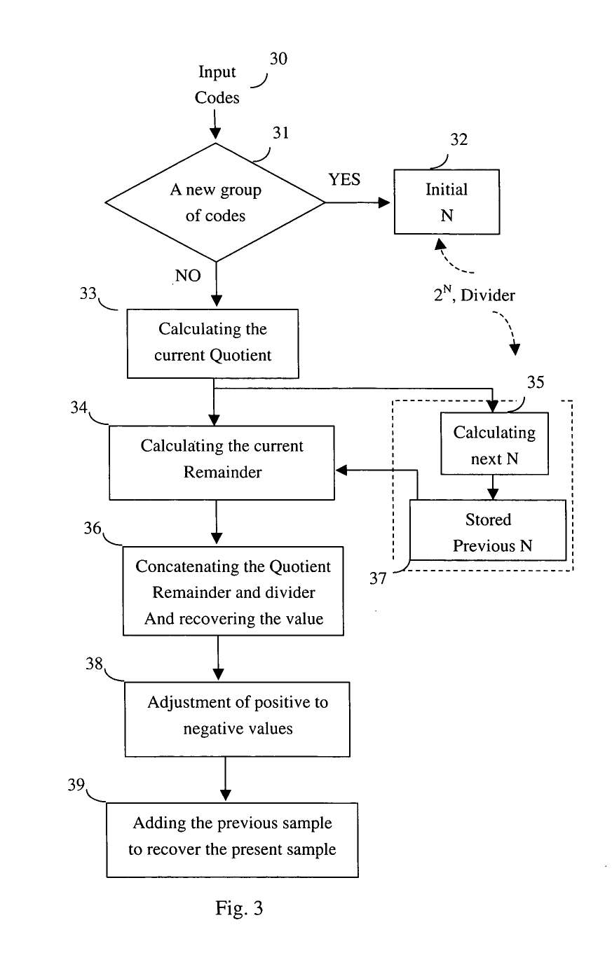

During decoding the data stream, as shown in FIG. 3, the code of data stream 30 is examined to decide whether this is a code of a new group 31 of samples, if yes, then, a separate calculation of N, 32 should be done with initially determined value, said “2”. After calculating the quotient 33, the value of quotient is used to decode the next N, 35, in the mean time, the previously decoded N, 37 is loaded to decode the remainder 34. After the three codes, quotient, remainder and divider are decoded, concatenating 36 all three codes will recover the differential value. In this invention of efficient coding the data stream, the negative differential value of adjacent samples is shifted to be positive, therefore, during decoding, the decoded differential value is to be shifted back 38 and to be added by previous sample 39 to completely recover to original data.

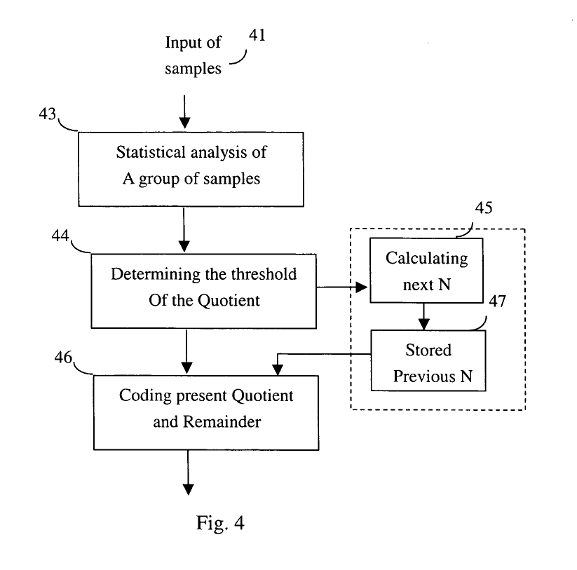

In some worst cases with large variance between adjacent samples within a group of samples, the differential value could be large and the codes required to represent the quotient and remainder after divided by the divider might be even longer then the length of the original samples. In this invention of coding the quotient and remainder with predicted divider, a threshold 44 is set to limit the length of the quotient as shown in FIG. 4. A group of input samples 41 is examined and statistically analyzed 43 by counting the variance range and random samples with sharp change of tone to help determining the threshold 46 of the quotient. Once the threshold of the quotient is determined, the N of the 2^{N}, the next divider 45 can be set accordingly. After the previous N and the threshold of the quotient are determined, the remainder 46 can then be calculated.

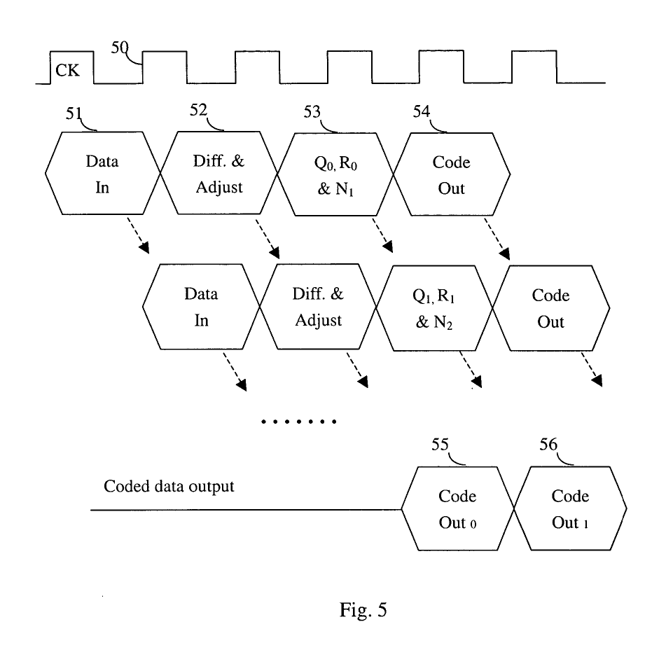

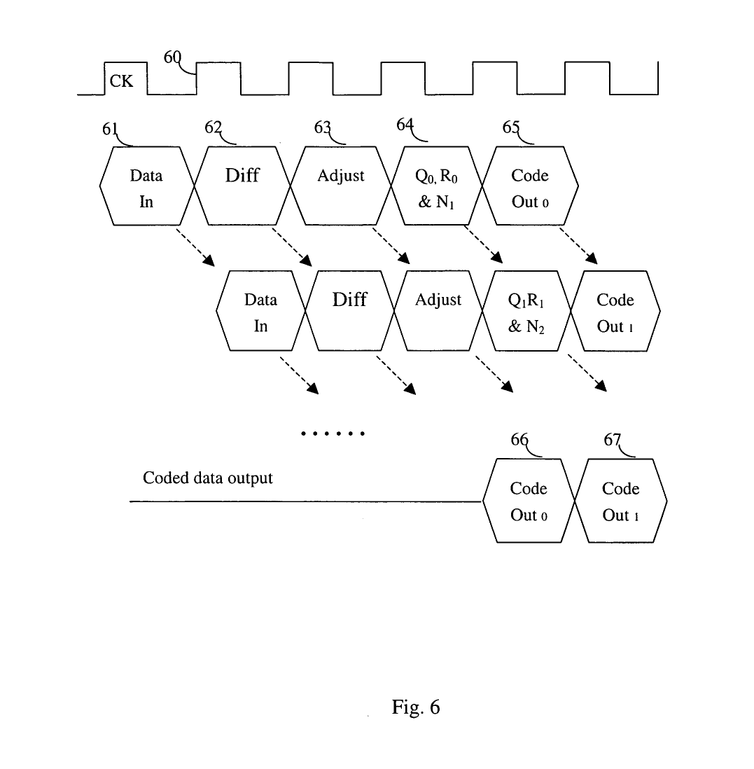

During implementation of this invention of efficiently lossless coding the data stream, the time delay for each procedure or said pipe of the coding is well distributed to for the optimized number of pipelining. As shown in FIG. 5, the implementation of this invention of efficiently coding the data stream is partitioned into 4 stages: fetching in the sampled data, calculating the differential value of adjacent samples and shifting to positive range, calculating the present quotient, remainder and the next N of 2^{N}, the divider and final stage of concatenating the codes of quotient and remainder and save into the output buffer. FIG. 5 illustrates an example of the a hardware or a VLSI design of implementing this invention is partitioned to be 4 pipes of calculating stages, for achieving highest throughput, the design includes the following hardware or VLSI block of Data input 51, Difference and shifting 52, Quotient, Remainder and Divider 53 and Data out stage 54. A timing control unit used to control the data flow is synchronized with CK 50, the clock signal. Each stage pipelining functions continuously and outputs the result to the next stage in clock cycle. In the 5^{th} clock cycle will there start continuously output data 55, 56b from the output stage. The example in FIG. 6 is a 5 stages design which compared the one of 4 stages has a key difference is that the stage 2 of 4 stages design has to calculate the differential value and to shift the negative to positive during one clock cycle. In FIG. 6, the Data input 61, Difference 62 and shifting 63, Quotient, Remainder and Divider 64 and Data out stage 65. Similar to that example in FIG. 5, a timing control unit used to control the data flow is synchronized with CK 60, the clock signal. Each stage pipelining functions continuously and outputs the result to the next stage in each synchronized clock cycle. The output stage continuously starts having output data 66, 67 after 5 stages after the 1^{st} fetched data enters the 1^{st} stage. When the length of the data sample is long, one clock cycle might not be enough to calculate the differential value of adjacent samples and shift the difference to be positive, and this stage can be divided to be two stages with one stage calculating the difference, the other functions as a shifter.

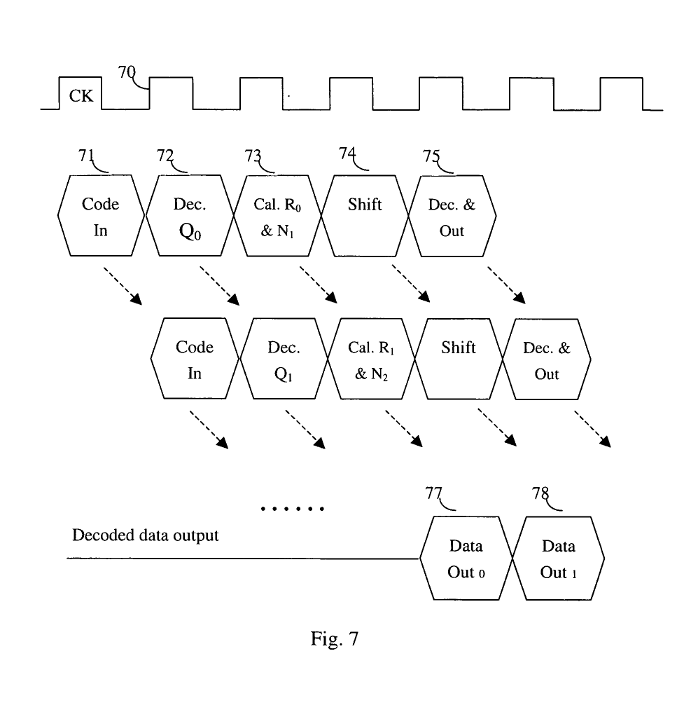

FIG. 7 shows an example of the implementation of 5 stages of decoding the data stream starts from fetching the coded data 71. The quotient is calculated 72 in the 2^{nd} stage, then, with the presence of the quotient and the next N 73 can be calculated and the previously estimated N is used to represent the remainder 73 of the present stage. The result of the quotient, remainder and the implicitly calculated divider can together then be concatenated 73 and shifted 74 to recover the original data. The last stage is the output stage 75. Exactly 5 clock cycles after fetching the 1^{st} coded data, the output stage continuously outputs the recovered data stream 77, 78.

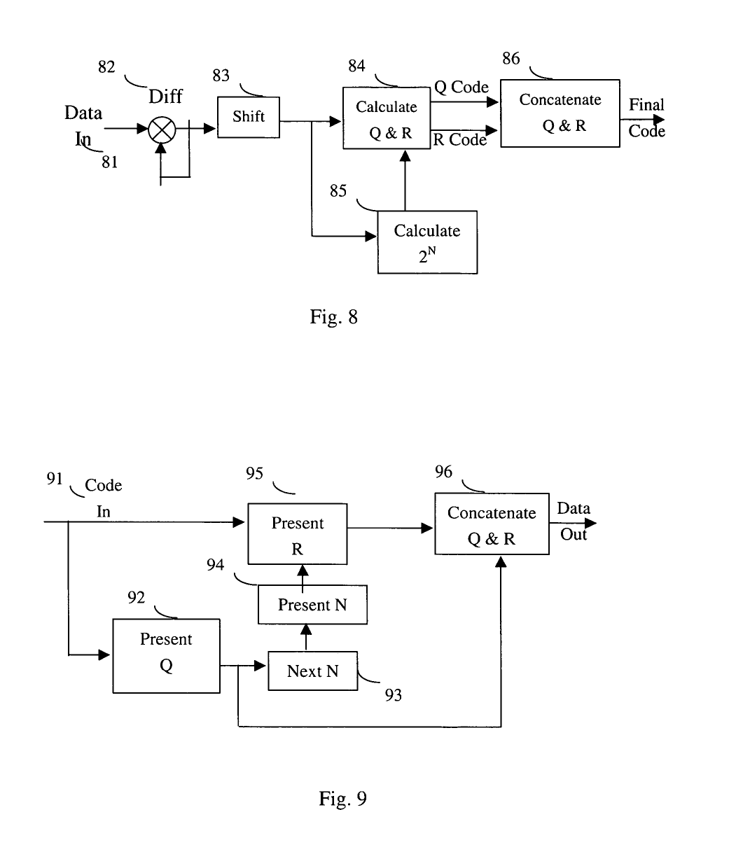

FIG. 8 depicts the block diagram of implementation of this invention of efficient lossless coding the data stream. The coming samples 81 of data is sent to be calculated the difference 82 of adjacent samples. And the result is shifted 83 to ensure that the VLC coding the data which is positive value to reduce number of bits to represent it. The next N 85 of 2^{N}, the divider of the shifted data can then calculated and the present N is used to represent the number of continuous “0” of the remainder. After the N is determined, the quotient (Q) and the remainder (R) can be counted 84 by Eq. 1. The last block concatenates the Q and R by inserting a marker bit which is contradictorily to the polarity of the Q and R.

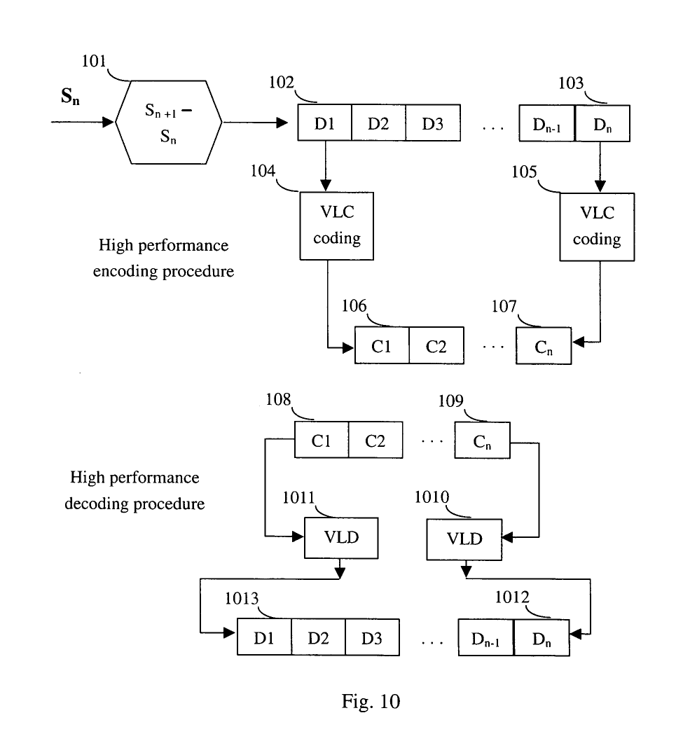

FIG. 9 illustrates the block diagram of the implementation of this invention of decoding the data stream. The encoded code is first fetched 91, and the quotient is calculated 92 by counting the continuous “0” or “1” which polarity is selected. After the present quotient is calculated, the next N 93 will then be calculated. With the present quotient and present N 94, the present R can be determined 95. Concatenating the Q and R recovers 96 the final output code. For pursuing higher performance, more hardware is added to encode and decode the image or audio data in parallel. FIG. 10 illustrates the procedure of the high performance data compression and decompression. The difference 101 of adjacent samples of a group of image or audio are saved in a temporary storage device 102, 103. When VLC encoding, there will be at least two hardware engines 104, 105 encoding the differential values of adjacent samples in parallel with one from the beginning of the temporary buffer, the other from the end of the temporary buffer. The encoded data stream is stored to a storage device with one stream being saved from the beginning 106 of the temporary storage device and the other from the end 107 of the storage device. When decompressing, the compressed data stream 108, 109 is sent to decoder with one end of data stream to a VLD 1011, the other end of data stream to another VLD 1010, and the decoded data stream are concatenated and saved into a data stream storage device 1012, 1013. The accessing point of the temporary storage device and be any position of the storage device and sequentially fetching the data from any direction.

It will be apparent to those skills in the art that various modifications and variations can be made to the structure of the present invention without departing from the scope or the spirit of the invention. In the view of the foregoing, it is intended that the present invention cover modifications and variations of this invention provided they fall within the scope of the following claims and their equivalents.

What is claimed is:

1. A method for efficiently coding the data stream, comprising:
Calculating the differential values between adjacent sampled data of a group of samples;
applying a variable length coding algorithm which includes but not limited to the following two procedures:
calculating and coding the value of “Quotient”;
calculating and coding the value of “Remainder”; and
implicitly estimating the value of the next divider, not assigning a code to represent the divider in the data stream.

2. The method of claim 1, wherein after calculating the differential values of adjacent samples, a procedure of shifting negative values to a predetermined range of positive range is applied to further reduce the data rate.

3. The method of claim 1, wherein the difference of adjacent samples is divided by a predetermined divider to obtain the Quotient and the Remainder.

4. The method of claim 1, wherein the Quotient is limited to a predetermined length.

5. The method of claim 1, wherein the code of the Quotient and the code of the Remainder are using the same polarity of digital bits.

6. The method of claim 1, wherein a predetermined bit which is different from the polarity of Quotient and Remainder is assigned to separate the code of the Quotient and the Remainder.

7. The method of claim 1, wherein the divider is represented by a nature number representing the power of 2.

8. The method of claim 1, wherein the initial divider of each group of samples is predetermined by statistic calculation.

9. The method of claim 1, wherein a larger value is assigned to represent the divider for a group of samples with larger differential value between adjacent samples.

10. A method for efficiently lossless decoding the reduced code and recovering the original data stream, comprising:
fetching the coded data stream temporarily stored in a buffer;
calculating the quotient;
calculating the remainder; and
determining the value of the next divider for the next sample.

11. The method of claim 10, wherein the value of the recovered divider is assigned to represent the number of bits of the remainder.

12. The method of claim 10, wherein the recovered quotient and the previous divider are used to decode the present divider.

13. An apparatus for efficiently lossless encoding and decoding the differential value of adjacent samples, comprising:
an engine calculating a quotient and a remainder so that the differential value of adjacent samples to be coded equals to the quotient multiplies the divider plus the remainder, wherein the quotient and the remainder are used for coding;
storing the compressed data stream into a temporary storage device and fetching the compressed data stream and storing to another temporary storage device for decoding;
at least two VLC encoders are used in encoding the difference of adjacent samples with the differential value input to one VLC encoder from one location of the temporary storage device and another input to another VLC encoder from another location of the temporary storage device; and
at least two VLD decoders are used in recovering the difference of adjacent samples with the input to one VLD decoder from one location of the temporary storage device of the compressed data stream and the input to another VLD decoder from another location of the temporary storage device.

14. The method of claim 13, wherein the quotient is decoded firstly and is used to recover the divider, with the recovered divider, the remainder equals to the value of the divider.

15. The method of claim 13, wherein the present divider equals to the sum of previous divider and the value of quotient divided by a predetermined parameter.

16. The method of claim 13, wherein the divider for recovering the next data sample is calculated during the same period of clock cycle with the calculation of present remainder.

17. The method of claim 13, wherein the initial value of the divider of the VLC coding is predetermined according the statistically estimated value of a group of samples.

18. The method of claim 13, wherein the temporary storage device for compressed data stream and decompressed data stream can be accessed sequentially from at least two positions of any location.

19. The method of claim 13, wherein the temporary storage device for compressed data stream and decompressed data stream can be sequentially accessed from any directions.
